(19) United States
(12) Patent Application Publication
(10) Pub. No.: US 2014/0182188 A1
(43) Pub. Date: Jul. 3, 2014

(54) MOTORIZED FISHING POLE

(71) Applicant: Danny BROWN, Vermontville, NY (US)

(72) Inventor: Danny BROWN, Vermontville, NY (US)

(21) Appl. No.: 13/733,831

(22) Filed: Jan. 3, 2013

(51) Int. Cl. A01K 87/00

(52) U.S. Cl. CPC A01K 87/00
USPC 43/18.1 R

(57) ABSTRACT

A motorized fishing pole comprising a housing, where the housing includes a motor to power movement of a fishing pole; an arm attached to the housing, where the arm is fastened to the housing on a pivot to enable up and down movement atop the housing; a receiving sleeve extending from the arm, where the receiving sleeve accepts a handle of the fishing pole; a twisting base attached to a bottom of the housing, where the twisting base enables right and left movement of the fishing pole; and a clamp with an opening to receive the twisting base, where the clamp enables fastening of the motorized fishing pole to an object.

### BACKGROUND OF THE INVENTION

1. Field of the Invention

The present invention relates to a support for a fishing pole where the support includes a motor which moves the fishing pole back and forth, front and back.

2. Description of Related Art

Fishing is a fun recreational and sporting activity enjoyed by many people. Some prefer to fish for pleasure while others fish for sport. Fishermen have their preferred methods to fish, but a few concepts are common to all; utilizing a hook and a line to snare a fish. Even thought the basic concept is simple, the techniques used have transformed fishing into what some consider an art form, with a preferred style for everyone. Within the art, different movement techniques have been developed to entice a fish. Some lures look like an insect thus the pole's movement is more sporadic to resemble the unpredictable motions of a bug on water. Alternatively, other lures may look like small bait fish, so the pole's movement changes accordingly to more fluid motions to resemble the bait fish gracefully swimming.

Depending on the type of fish desired to be caught and the location for fishing, one or more techniques may come into play. Sometimes to maximize the number of fish caught the fisherman may employ multiple poles at once. This quickly becomes tiresome for a fisherman having to continuously move and monitor their fishing poles. Only one pole is actively moving at a time causing the other poles to become stationary until the fisherman returns. This is why it would be desirable in the art to provide a fishing pole that operates independently from the fisherman. It would also be beneficial in the art to provide a moving fishing pole that enables exchange between multiple poles.

### SUMMARY OF THE INVENTION

In view of the foregoing disadvantages inherent in the prior art, the general purpose of the present invention is to provide a motorized fishing pole, configured to include all of the advantages of the prior art, and to overcome the drawbacks inherent therein.

Accordingly, an object of the present invention is to provide a motorized fishing pole where an internal motor creates up and down, and right and left movement.

Another object of the present invention is to provide a motorized fishing pole which enables exchange between multiple fishing poles.

Yet another object of the present invention is to provide a motorized fishing pole with a clamp to allow for pole attachment to a variety of different objects.

To achieve the above objects, in an aspect of the present invention, a motorized fishing pole is described comprising a housing, where the housing includes a motor to power movement of a fishing pole; an arm attached to the housing, where the arm is fastened to the housing on a pivot to enable up and down movement atop the housing; a receiving sleeve extending from the arm, where the receiving sleeve accepts a handle of the fishing pole; a twisting base attached to a bottom of the housing, where the twisting base enables right and left movement of the fishing pole; and a clamp with an opening to receive the twisting base, where the clamp enables fastening of the motorized fishing pole to an object.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing in which:

FIG. 1 depicts a perspective view of a motorized fishing pole in accordance with an exemplary embodiment of the present invention.

### DETAILED DESCRIPTION OF THE DRAWINGS

The present invention relates to a support for a fishing pole where the support includes a motor which moves the fishing pole back and forth, front and back. The motorized fishing pole is a lightweight device that may be positioned on a variety of objects like the deck of a boat or a rail of a pier. A hinged arm moves the fishing pole back and forth to replicate the movement style of the fisherman. A standard fishing pole may be inserted in the arm to allow for exchange between different types of poles as desired by the user. The motorized fishing pole may be utilized with standard recreational fishing poles or commercial sized poles.

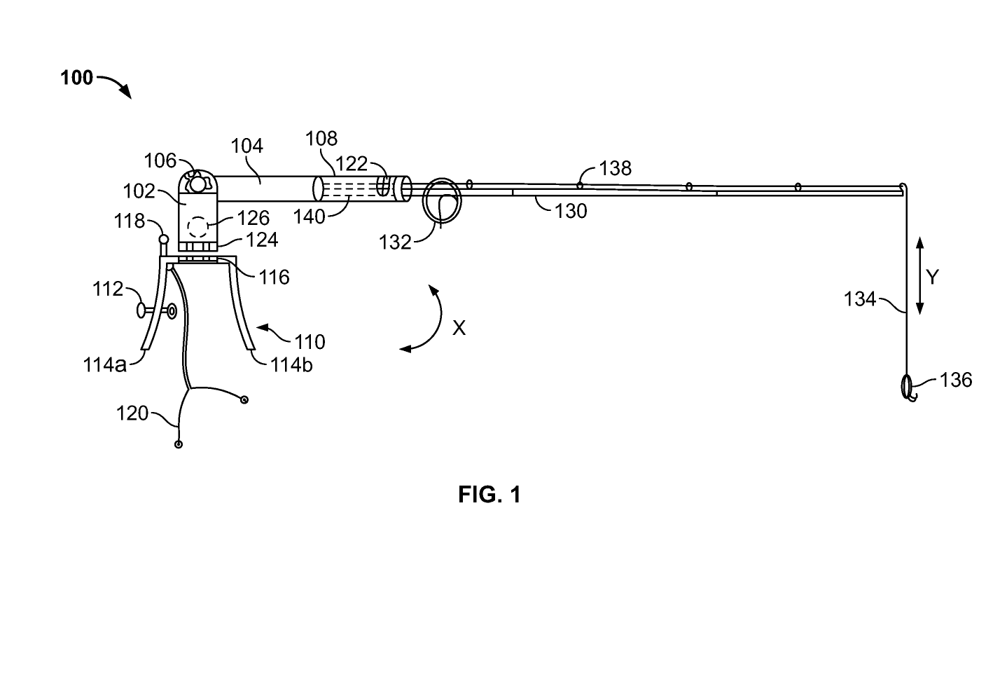

Turning now descriptively to the drawings, referring to FIG. 1, a perspective view of a motorized fishing pole 100 is shown in accordance with an exemplary embodiment of the present invention. The motorized fishing pole 100 includes a housing 102 with an internal motor. The motor within the housing 102 controls the movement of the motorized fishing pole 100 from up and down to left and right. Attached to the housing 102 is an arm 104 which rotates on a pivot 106. The pivot 106 may rotate the arm 104 180° about the housing 102. The arm 104 may move further in the direction illustrated with the arrow X. The motorized fishing pole 100 may be made from a lightweight aluminum or plastic material.

Extending from the arm 104 is a receiving sleeve 108. The receiving sleeve 108 accepts a handle 140 of a fishing pole 130. The fishing pole 130 may be removed from the receiving sleeve 108 to allow for exchange between different fishing poles. The fishing pole 130 may be secured within the receiving sleeve 108 with a lock 122. The lock 122 may enable different sized fishing poles to securely fasten into the receiving sleeve 108 by adjustably fitting around the handle 140. While locked within the receiving sleeve 108, the fishing line 134 is anchored at a reel 132 and threaded through a plurality of eyelets 138. At the end of the line 134 the user may attach their preferred lure 136 to drop into the water. The lure 136 moves towards and away from the end of the fishing pole 130 in the direction of arrow Y.

Referring now back to the housing 102, the housing 102 is positioned upon a clamp 110. The clamp 110 enables the motorized fishing pole 100 to be attached to a variety of different places. For example, the clamp may attach to an edge of a boat, a rail on a dock, or a branch of a tree. The clamp 110 includes an adjustor 112 and a pair of arms 114a, 114b. The adjustor 112 screws into place to brace an object between the clamp arms 114a, 114b.

At a top portion of the clamp 110 may be an opening 116, where the opening 116 receives a twisting base 124 of the housing 102. The twisting base 124 may rotate within the opening to enable left and right movement of the fishing pole 130 when attached to the housing 102. Next to the opening 116 may be a controller 118 which is electronically coupled to the housing 102 through the base 124. The controller 118 controls the directional movement of the motorized fishing pole 100, activating the pivot 106 to move up and down or the twisting base 124 to move right and left. Specific movement patterns may be programmed into the motor and the controller 118 to replicate more realistic movements of the lure 136 on the line 134. The controller 116 may alternatively be attached directly to the housing 102. A timer may be incorporated into the motor to allow the motorized fishing pole 100 to run for a predetermined amount of time. Extending from the controller 118 may be a power cord 120. The power cord 120 may connect to an electronic power source within a boat. Alternatively, a battery 126 may be within the housing 102 to enable operation without an external source.

With the motorized fishing pole the user may leisurely monitor the line while the motor continuously controls the movement. The motorized fishing pole may be programmed to implement a variety of different fishing methods including trolling, drifting or anchoring. The user is able to perform other tasks while allowing the motorized fishing pole to take over the baiting portion of fishing. More than one motorized fishing pole may be used at once allowing the user to monitor multiple fishing poles at once, simply waiting until a fish is on one of the lines to reel it in. Simultaneous operation of multiple active fishing poles may multiply the amount of fish caught exponentially, thereby creating a more exciting fishing experience.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A motorized fishing pole comprising:
a. a housing, where the housing includes a motor to power movement of a fishing pole;
b. an arm attached to the housing, where the arm is fastened to the housing on a pivot to enable up and down movement atop the housing;
c. a receiving sleeve extending from the arm, where the receiving sleeve accepts a handle of the fishing pole;
d. a twisting base attached to a bottom of the housing, where the twisting base enables right and left movement of the fishing pole; and
e. a clamp with an opening to receive the twisting base, where the clamp enables fastening of the motorized fishing pole to an object.

2. The motorized fishing pole according to claim 1, where the clamp includes an adjustor and a pair of arms, where the adjustor screws to tighten the arms around the object.

3. The motorized fishing pole according to claim 1, where the housing includes a battery.

4. The motorized fishing pole according to claim 1, where the motorized fishing pole includes a controller to operate motions of the pivot and the twisting base.

5. The motorized fishing pole according to claim 4, where the controller is positioned on the clamp.

6. The motorized fishing pole according to claim 4, where the controller is positioned on the housing.

7. The motorized fishing pole according to claim 1, where the receiving sleeve enables exchange between more than one fishing pole.

8. The motorized fishing pole according to claim 1, where the movement created by the housing includes one of at least trolling, drifting and anchoring.

9. The motorized fishing pole according to claim 1, where the housing includes a timer.

10. The motorized fishing pole according to claim 1, where the housing includes a power cord to allow the motorized fishing pole to connect to an external electrical source.
